(19) United States
(12) Patent Application Publication
(10) Pub. No.: US 2019/0188102 A1
(43) Pub. Date: Jun. 20, 2019

(54) METHOD AND SYSTEM FOR DATA RECOVERY IN A CLOUD BASED COMPUTING ENVIRONMENT UTILIZING OBJECT STORAGE

(71) Applicant: CloudEndure Ltd., Ramat Gan (IL)

(72) Inventors: Leonid FEINBERG, Ramat HaSharon (IL); Ofir EHRLICH, Netanya (IL); Sigal WEINER, Holon (IL); Eran WEISS, Givata'im (IL); Ophir SETTER, Ramat Gan (IL); Kosta SHOUGAEV, Rehovot (IL)

(73) Assignee: CloudEndure Ltd., Ramat Gan (IL)

(21) Appl. No.: 16/203,110

(22) Filed: Nov. 28, 2018

Related U.S. Application Data
(63) Continuation-in-part of application No. 14/870,652, filed on Sep. 30, 2015.
Application No. 14/870,652 is a continuation-in-part of application No. 15/196,899, filed on Jun. 29, 2016, now Pat. No. 10,191,823.
Application No. 15/196,899 is a continuation-in-part of application No. 15/433,640, filed on Feb. 15, 2017.
Application No. 15/433,640 is a continuation of application No. 14/205,083, filed on Mar. 11, 2014, now Pat. No. 9,582,386.
(60) Provisional application No. 62/594,867, filed on Dec. 5, 2017.
(60) Provisional application No. 62/273,806, filed on Dec. 31, 2015.
(60) Provisional application No. 61/787,178, filed on Mar. 15, 2013.

(51) Int. Cl. G06F 11/20; G06F 11/14

(52) U.S. Cl. CPC G06F 11/2094; G06F 11/1482; H04L 67/10; G06F 2201/85; G06F 11/2097

(57) ABSTRACT

A system and method for replicating block storage to an object storage, the method including: receiving write instructions from an original component (OC) in a first network, wherein the write instructions include a data block; mapping the write instructions to at least one object in the object storage; and storing the data block of the write instructions in the mapped at least one object in a second network.

### CROSS-REFERENCE TO RELATED APPLICATIONS

This application claims the benefit of U.S. Provisional Application No. 62/594,867 filed on Dec. 5, 2017. This application is also a continuation-in-part of:

(a) U.S. patent application Ser. No. 14/870,652 filed on Sep. 30, 2015, now pending;

(b) U.S. patent application Ser. No. 15/196,899, filed on Jun. 29, 2016, now pending, which claims the benefit of U.S. Provisional Application No. 62/273,806 filed on Dec. 31, 2015; and

(c) U.S. patent application Ser. No. 15/433,640 filed on Feb. 15, 2017, now pending, which is a continuation of U.S. patent application Ser. No. 14/205,083 filed on Mar. 11, 2014, now U.S. Pat. No. 9,582,386, which claims the benefit of U.S. Provisional Application No. 61/787,178 filed on Mar. 15, 2013.

The contents of the above-referenced applications are hereby incorporated by reference.

### TECHNICAL FIELD

The present disclosure relates generally to data recovery, and particularly to improving storage costs in replication systems for data recovery.

### BACKGROUND

Many data recovery plans include replicating data from an internal source environment to a network environment, such as a cloud based computing environment. However, often the recovery data is not used, and therefore storing it simultaneously in both in an original first location and a backup second location can become costly. These costs increase as the scale of the recover data grows, and can account for a substantial portion of total data cost. Typically, block storage is used for such replications schemes, resulting in the elevated cost. Block storage involved storing data in volumes, or blocks, which can include individual hard drives, and are assigned an identification label without additional metadata.

While block storage is low-latency and is well supported, it does introduce a number of disadvantages. First, block storage can be expensive to store data in individual volumes. While cheaper alternatives to block storage exists, including object storage, such alternatives typically have lower latency and throughput than block storage. As such, object storage is not well suited for applications where data is accessed frequently (e.g., multiple read/writes), since cost is often associated with the number of times files are accessed.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for replicating block storage to an object storage, the method including: receiving write instructions from an original component (OC) in a first network, wherein the write instructions include a data block; mapping the write instructions to at least one object in the object storage; and storing the data block of the write instructions in the mapped at least one object in a second network.

Certain embodiments disclosed herein also include a non-transitory computer readable medium having stored thereon instructions for causing a processing circuitry to perform a process, the process including: receiving write instructions from an original component (OC) in a first network, wherein the write instructions include a data block; mapping the write instructions to at least one object in the object storage; and storing the data block of the write instructions in the mapped at least one object in a second network.

Certain embodiments disclosed herein also include a system for replicating block storage to an object storage, including: a processing circuitry; and a memory, the memory containing instructions that, when executed by the processing circuitry, configure the system to: receive write instructions from an original component (OC) in a first network, wherein the write instructions include a data block; map the write instructions to at least one object in the object storage; and store the data block of the write instructions in the mapped at least one object in a second network.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram of a data replication scheme over a network, according to an embodiment.

FIG. 2 is a block diagram of a mapping scheme from a block storage to an object storage, according to an embodiment.

FIG. 3 is a network diagram of a data recovery system utilizing object storage, according to an embodiment.

FIG. 4 is a flowchart of a method for replicating a block storage to an object storage, according to an embodiment.

FIG. 5 is a flowchart of a method for performing replication of an original component to a replicated component, where replicated content of the original component resides in an object storage, according to an embodiment.

FIG. 6 is a block diagram of an orchestration server implemented according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

In storing and retrieving data, object storage is a cheaper alternative to block storage.

However that reduction in price comes at the expense of latency and throughput, both of which are higher for block storage when compared to object storage. The system and method disclosed herein make use of an object storage to store data blocks of a block storage. In some embodiments, a portion of the replicated data may be stored in the block storage, and a portion in an object storage. One or more data blocks are mapped to one or more objects in an object storage. For example, a first object corresponding to a logical block address can contain therein one or more data blocks, each corresponding to a different time, allowing creation of discrete points in time to which a replicated disk may be restored to.

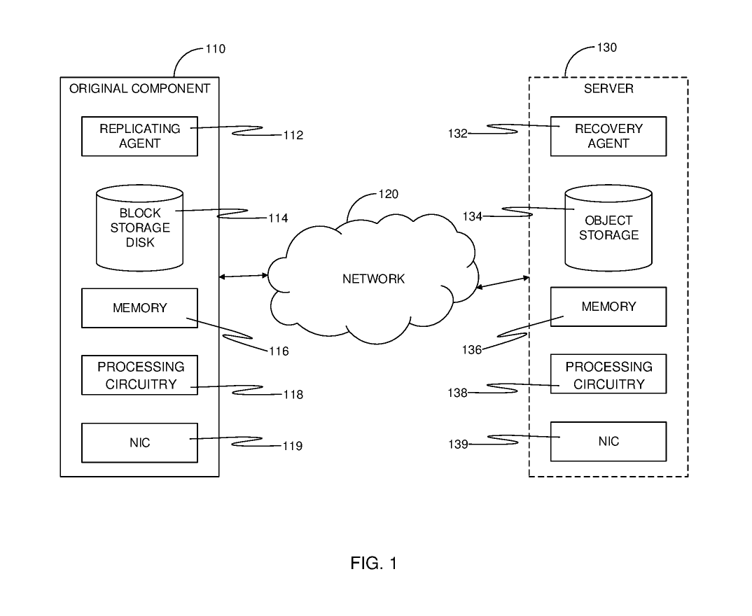

FIG. 1 is a block diagram of a replication scheme over a network according to an embodiment. An original component (OC) 110 includes a replicating agent 112 and one or more block storage devices, such as block storage disk 114. The OC 110 may further include a memory 116 having stored thereon instructions that, when executed by a processing circuitry 118, configure the replicating agent to perform the functions discussed in more detail herein. The OC 110 also includes a network interface controller (NIC) 119, which allows the OC 110 to communicate over a network 120.

In an embodiment, the network 120 may be configured to provide connectivity of various sorts, as may be necessary, including but not limited to, wired or wireless connectivity, including, for example, local area network (LAN), wide area network (WAN), metro area network (MAN), worldwide web (WWW), Internet, and any combination thereof, as well as cellular connectivity.

The network 120 further provides connectivity to a replication server 130. In an example embodiment the server 130 includes a recovery agent 132 and is communicatively connected with one or more object storages, such as object storage 134. The replication server 130 may access the object storage 134 through an API. In certain embodiments, the replicating agent 132 may access the object storage 134 directly, for example through the API. In some embodiments, the replication server 130 or the OC 110 can be each in a cloud based computing environment (CBCE), or both be in the same CBCE. The replication server 130 may further include a memory 136, a processing circuitry 138 and a NIC 139.

A replicating agent 112 is configured to detect write instructions directed at the block storage disk 114, for example by monitoring disk input and output (I/O) activity. In an embodiment, the replicating agent 112 is configured to send the write instructions over the network to the replication server 130, e.g., when disk I/O is detected. In other embodiments, the replicating agent 112 may send write instructions to the object storage 134. A write instruction may include, for example, one or more block addresses, and corresponding data block(s) to be written to the one or more block addresses, and metadata corresponding to the write operation, to the data, and the like.

In an embodiment, the replicating agent 112 may store one or more write instructions to a queue, implemented for example as part of the memory 116, and periodically send the one or more instructions to the replication server 130 (or the object storage) over the network 120. For example, the replicating agent 112 may send the write instructions when a number of write instructions exceed a first threshold, when the number of data blocks associated with the write instructions exceeds a second threshold, within a time frame corresponding to a frequency, or any combination thereof. Any of the thresholds, and the frequency, may be static, dynamic, or adaptive.

A recovery agent 132 may be configured to receive write instructions from one or more replicating agents, each installed on the original component (OC), such as OC 110. The recovery agent 132 may initially store one or more received write instructions in a queue, which may be implemented, for example, on the memory 136. The recovery agent 132 may store a group of writes, which may include data blocks, received metadata, and generated metadata in an object of the object storage 134. Generated metadata may be generated by the recovery agent 132 and may be based on the data blocks. For example, a hash, or checksum may be generated based on the data blocks and stored in the same object. Thus, the recovery agent 132 may check if an object should be updated with new data by checking the metadata. If, for example, a new data block does not change the checksum result, then it may be acceptable to skip writing the new data block. If the checksums do not match, the object should be updated. By only checking the generated metadata, this technique reduces the amount of data necessary to read, or the number of read instructions. Some object storage systems charge fees according to a number of reads and/or writes. In such systems, decreasing that number is more economical.

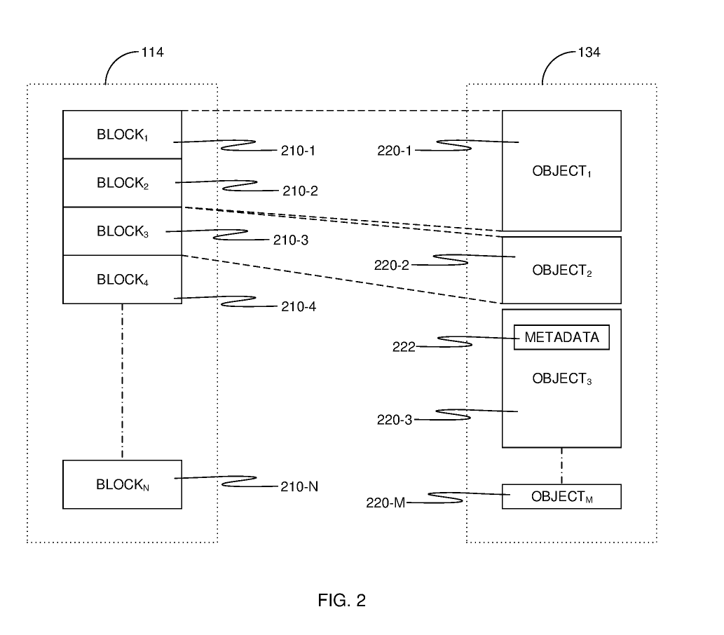

In an embodiment, the recovery agent 132 generates a mapping table (detailed in FIG. 2), which maps one or more data blocks to one or more objects of an object storage 134. The mapping table may be stored in an object, on another storage communicatively connected with the recovery agent 132, in a portion of memory 136, and the like. In certain other embodiments, the mapping table may be generated by the replicating agent 112, for example when sending the write instructions directly to the object storage. The mapping table may be stored in a persistent storage (not shown), such as a block storage, which may be communicatively connected to the replication server 130.

FIG. 2 is a block diagram of a mapping scheme from a block storage 114 to an object storage 134 according to an embodiment. A block storage 114 includes a plurality of data blocks, 210-1 through 210-N, where ‘N’ is an integer equal to or greater than 2. A data block is a fixed size of sequential bytes or bits. The data block may include associated metadata, which may be stored in each data block, or as a metadata block, such as data block 210-N. An object storage 134 includes a plurality of objects 220-1 through 220-M, where ‘M’ is an integer equal to or greater than 2. An object 220 may store therein one or more data blocks 210. For example, object 220-1 stores therein data blocks 210-1 and 210-2. Object 220-2 stores therein block 210-3.

An object may include metadata, such as metadata 222 of object 220-3. Metadata may include, for example, a fingerprint or signature of the data stored in the object (such as a checksum, hash, and the like.). Metadata may also include a unique identifier (such as a key) through which the object can be recalled from storage to memory (i.e. read). In some exemplary embodiments, a table mapping which blocks are written to which objects is stored, for example in a designated object, such as object 220-M. In some embodiments, a recovery agent may periodically update the mapping table.

It should be noted that object storages are typically used for storing unstructured data. Certain services offer use of object storage in a cloud based computing environment, where the object storage is typically slower compared to block storage. The benefit offered by object storage is that the cost structure of object storage is often not per amount of data, but per number of read and/or write instructions. For data which is updated at a relatively slow pace and for which immediate access is not pertinent, such services may be more advantageous.

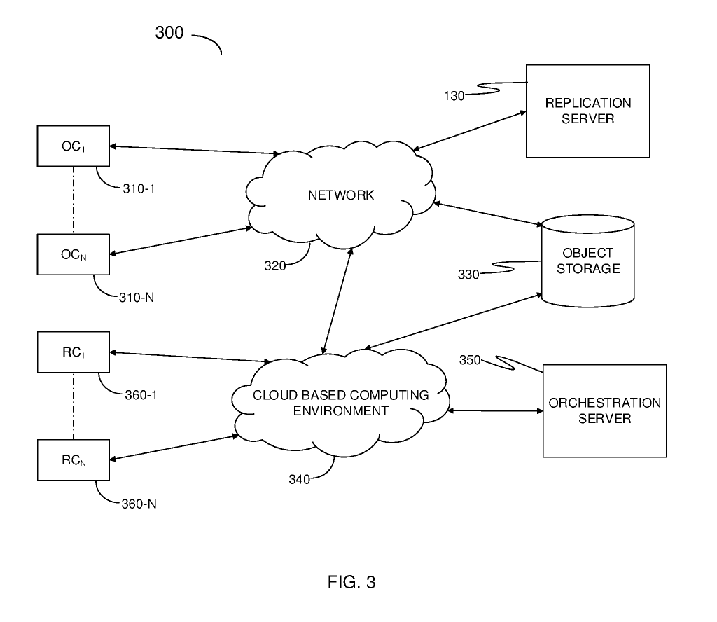

FIG. 3 is an example network diagram of a data recovery system 300 utilizing object storage according to an embodiment. While data recovery is discussed in this exemplary embodiment, the teachings herein can also be used for performing data backup, testing system robustness, disaster recovery, and the like, all without departing from the scope of this disclosure. A plurality of original component (OCs) 310-1 through 310-N are communicatively connected with a network 320. The network 320 may provide connectivity of various sorts as described herein, and as may be necessary, including but not limited to, wired and/or wireless connectivity, including, for example, local area network (LAN), wide area network (WAN), metro area network (MAN), worldwide web (WWW), Internet, and any combination thereof, as well as cellular connectivity.

The network 320 further provides connectivity to an object storage 330, a replication server 130, and a cloud-based computing environment (CBCE) 340. The object storage 330 includes an application programming interface (API) through which the object storage 330 may be accessed. An object storage typically includes one or more storage servers, each having one or more storage devices. A replication agent, a recovery agent (neither shown), the replication server 130, or the orchestration server 350 may each communicate directly with the object storage 330 via the API. In an embodiment, the CBCE 340 may include therein a network, including physical and logical components, such as switches, virtual private networks (VPNs), servers, storage devices, and the like.

The CBCE 340 is communicatively connected to an orchestration server 350, and a plurality of replicated components (RCs) 360-1 through 360-N, where ‘N’ is an integer equal to or greater than 2, such that each RC corresponds to an OC (for example, RC 360-1 corresponds to OC 310-1, and so on). The orchestration server 350 is operative for initializing instances in the CBCE 340. An instance may be a replicated component corresponding to the original component. In this way, when an original component is taken offline, or is unavailable for whatever reason, rather than halt the service which was being provided by the OC, a corresponding RC is initiated in the CBCE to assume its place. When and if the OC is operational, the RC may be taken offline and the OC will resume operation as usual.

In one embodiment, a replication agent (not shown) running on an OC 310 is configured to send disk write instructions to a recovery agent (not shown) running on the replication server 130. In other embodiments, the replication agent may send the write instructions to the object storage 330. In response to a detected failure in the operation of an OC, for example OC 310-1, the orchestration server 350 may initiate a replicated component to assume the operation of OC 310-1. In this case, this is RC 360-1.

It should be noted that while the orchestration server 350 may initialize a disk on the RC 360-1 corresponding to a disk of OC 310-1, the contents of the disk may need to be replicated thereto. The orchestration server 350 may request the contents of the disk from the object storage 330 directly, or by requesting from a recovery agent running on the replication server 130. The recovery agent may determine, from a mapping table, one or more objects in which data blocks are stored, and which may be replicated to the RC 360-1. The object storage 330 may then send the data to the RC 360-1.

In an embodiment, the orchestration server 350 does not replicate the contents of the disk immediately. As reading large volumes of data from an object storage may be expensive and slow, it could be advantageous in some embodiments to replicate data to the RC, or provide the data directly from the object storage 330, in response to receiving a request for the data from the RC. For example, if an OC 310-N requests data from RC 360-1 (rather than requesting the data from the failed OC 310-1), a recovery agent running on RC 360-1 may detect that the block storage of the RC 360-1 does not have the requested data. The recovery agent, e.g. a recovery agent running on the replication server 130, may then initialize a recovery of the data which is being requested from the object storage server 330. The object storage 330 may determine from the mapping table where the one or more data blocks corresponding to the request reside, read the one or more data blocks from the object storage, then send them to the RC 360-1. The RC 360-1 may then store the data blocks in memory, or in a block storage corresponding to the OC block storage device.

In another embodiment, a request for data from the original component block storage device may be redirected to the object storage 330. An interface may be initialized, for example by the orchestration server 350, so that any requests for data blocks from the block storage device are redirected to the object storage 330. In effect, such an interface would serve as an abstraction layer between a requesting node (such as another original component 310) and the object storage 330, so that the requesting node would not be aware that it is receiving data from the object storage 330. In certain embodiments, a dedicated restore server (not shown) may be initialized, having the interface and providing connectivity to the object storage 330 thereto as detailed above.

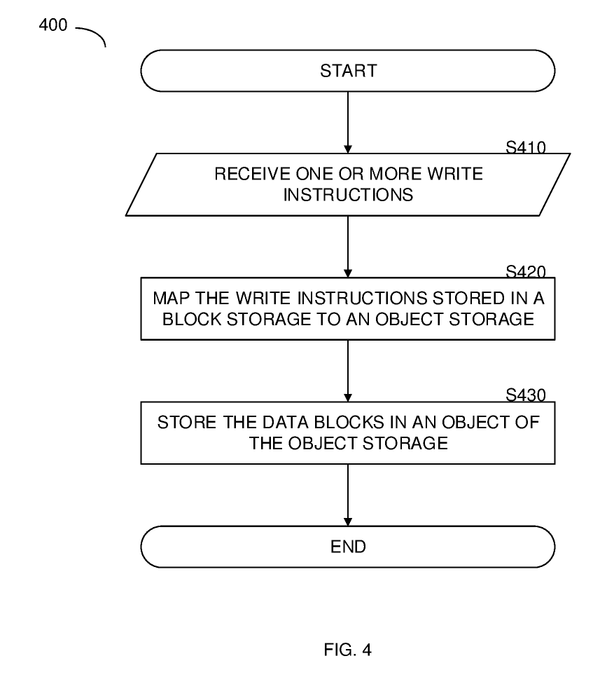

FIG. 4 is an example flowchart 400 of a method for replicating a block storage to an object storage according to an embodiment. The method may be used for data recovery, backup, testing, and the like. In some embodiments, the method begins with an original component storage device which contains no data. In such embodiments, the method may begin as detailed. In certain embodiments, the method may begin with an original component storage device which contains thereon data on one or more data blocks. In such embodiments the method may begin by performing a replication from an original component storage device and an object storage, for example by utilizing a portion of the teachings of U.S. patent application Ser. No. 14/636,233, incorporated by reference herein.

At S410, one or more write instructions are received from a replicating agent running on an original component of a first computing environment. The first computing environment may be a cloud based computing environment, or other networked computing environment. In certain embodiments, the replicating agent may store instructions in a queue and periodically send a group of write instructions, for example in response to the number of write instructions exceeding a first threshold. A write instruction may include one or more data blocks and metadata corresponding to the same. In some embodiments, write instructions may be sent to a persistent storage (for example a non-volatile memory storage device) for storage until they are committed to an object storage.

At S420, one or more data blocks corresponding to the one or more write instructions are mapped to one or more objects of an object storage. The mapping may include, in an embodiment, a mapping table having stored therein a block address associated with an object identifier, such that each block address corresponds at least to an object identifier, and each object identifier corresponds to at least a data block. In some embodiments, metadata related to the stored data blocks may be generated by the object storage, and stored with the object. For example, a first block having stored thereon a first data may be stored in a first object. In some other embodiments, an address of a data block may be mapped to a plurality of objects, where each object may store the contents of the data block as they were stored at a certain period of time. For example, a first data block may be mapped to a first object and a second object, such that the first object stores the first data block at t0 and the second object stores the first data block at t1, where t1 and t0 are points in time which are not equal to each other.

At S430, the one or more data blocks are stored in the one or more mapped objects of the object storage. In some embodiments, a recovery agent communicatively connected with the object storage may store a group of write instructions in a queue, for example in a non-persistent memory such as RAM, of a recovery server, and perform a subsequent mapping and storing in the object storage in response to the number of write instructions in the group exceeding a first threshold, the size in bits of the write instructions exceeding a second threshold, or periodically, with a given frequency, combinations thereof, and the like. The thresholds and the frequency may be static, dynamic or adaptive. In certain embodiments, a plurality of write instructions of a data block may be stored in a first persistent storage, each write instruction including a timestamp, and the data block stored in one or more objects of an object storage. Periodically, the stored data block on the object storage may be updated with a write instruction of the plurality of write instructions. In an embodiment, the first persistent storage stores write instructions which allow continuous recovery points of a data block, while the object storage stores data of a data block in discrete points in time. By performing a write instruction on the data block in the object storage, the data block is recovered to the point in time at which the write instruction was generated.

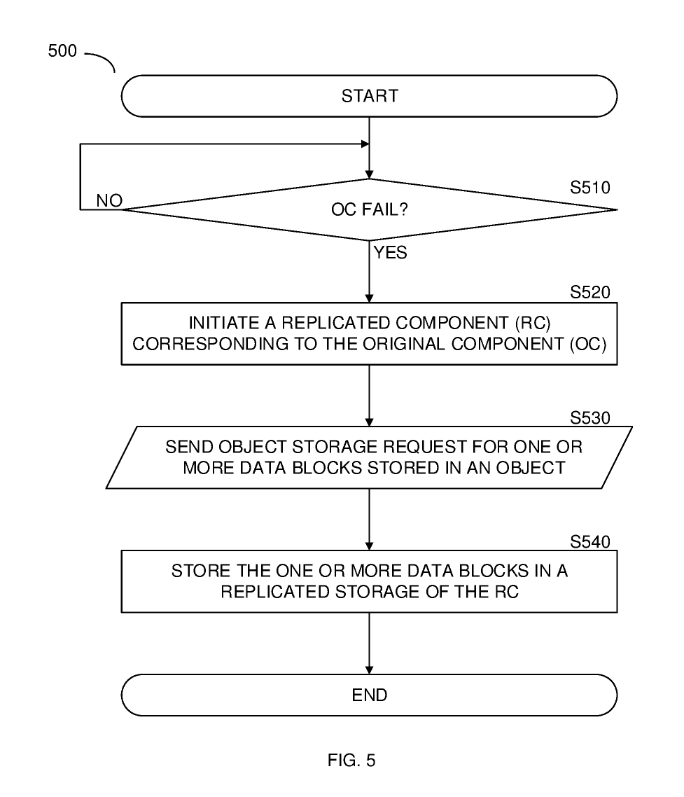

FIG. 5 is an example flowchart 500 of a method for performing replication of an original component to a replicated component, where the replicated content of the original component resides in an object storage, according to an embodiment.

At S510, a check is performed to determine if an original component, such as OC 310-1 of FIG. 3, is in a failure mode. A failed component may be, for example, a server which is down, a service which is unresponsive, or has response times which are lower than a predefined threshold, and the like. If failure is detected, execution continues at S520, otherwise execution restarts at S510. In this exemplary embodiment, a check is performed to determine failure mode. However, in other embodiments the method may be used for restoring data from a backup, setting up a replicated component for testing purposes (for example to gauge performance when scaling up).

At S520, a replicated component corresponding to the OC is initiated, e.g., via an orchestration server in a cloud-based computing environment, such as RC 360-1 in FIG. 3. In some embodiments, the replicated component may be initiated in a networking environment other than a CBCE. The RC includes all subcomponents of the OC, such as memory, disk storage, identifier in a namespace, and the like, so that the RC can assume the roles of the OC with minimal affect to other services, servers, or other components which may require use of the OC.

At S530, a request is sent, e.g., from the orchestration server to an object storage server, to replicate one or more data blocks of a block storage of the OC into the block storage of the RC. In some embodiments, the RC may request one or more blocks directly from the object storage server. In certain embodiments, the RC may send the request to the object storage server in response to receiving a request for data from one or more data blocks which the RC does not have stored thereon. By performing the retrieval ad hoc in response to requests, the number of reads from the object storage may be reduced, potentially saving on resources and resulting in a less expensive service. Typically, this is done at the expense of response time, as having all the data restored on the RC would result in a higher availability. In certain embodiments, the RC, orchestration server, or object storage server, may determine which blocks are accessed frequently, and begin the recovery process by reading the objects which contain therein those data blocks, and sending them to the RC for storing on the replicated block storage. A request for a data block from the RC or orchestration server to the object storage server may include a block address, and an identifier corresponding to the block storage and/or the OC. The object storage server may reference this information and perform a search on the metadata stored thereon the determine which object corresponds to the requested one or more blocks of data.

At S540, the one or more data blocks are written, e.g., to a replicated block storage device corresponding to an original block storage device. In some embodiments retrieving data from the object storage does not necessitate replicating the original component. Data may be retrieved directly from the object storage, for example through an API.

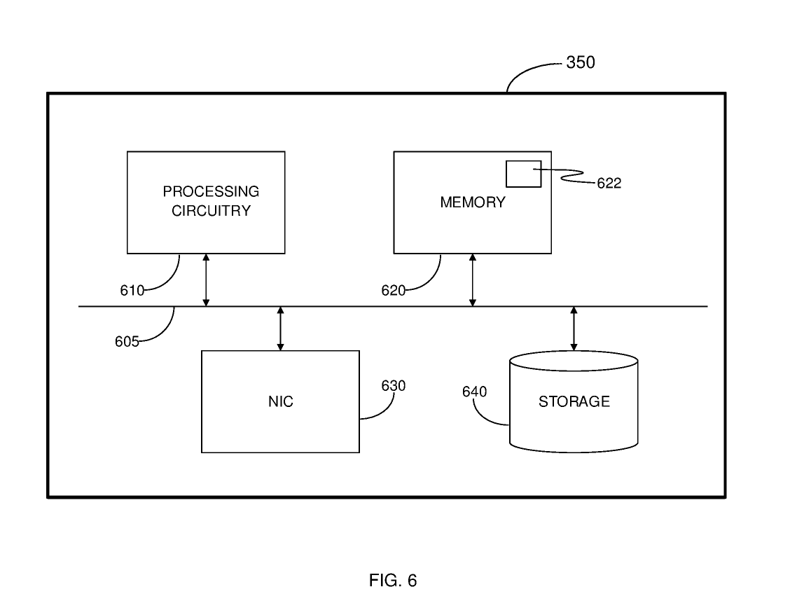

FIG. 6 is an example block diagram of the orchestration server 350 implemented according to an embodiment. The orchestration server 350 includes at least one processing circuitry 610, for example, a central processing unit (CPU). In an embodiment, the processing circuitry 610 may be, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing circuitry 610 is connected via a bus 605 to a memory 620. The memory 620 may include a memory portion 622 that contains instructions that, when executed by the processing circuitry 610, performs the method described in more detail herein. The memory 620 may be further used as a working scratch pad for the processing element 610, a temporary storage, and others, as the case may be. The memory 620 may be a volatile memory such as, but not limited to random access memory (RAM), or non-volatile memory (NVM), such as, but not limited to, flash memory.

The processing element 610 may be further connected to network interface controller (NIC) 630. The NIC 630 may provide connectivity of various sorts, for example to a network such as network 320, or CBCE 340.

The processing circuitry 610 may be further connected with a storage 640. The storage 640 may be used for the purpose of holding a copy of the methods executed in accordance with the disclosed techniques. The processing circuitry 610 and the memory 620 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described in further detail herein.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for replicating block storage to an object storage, the method comprising:
receiving write instructions from an original component (OC) in a first network, wherein the write instructions include a data block;
mapping the write instructions to at least one object in the object storage; and
storing the data block of the write instructions in the mapped at least one object in a second network.

2. The method of claim 1, further comprising:
storing metadata associated with the data block in a storage map.

3. The method of claim 2, wherein the metadata includes at least one of: a timestamp and a logical address.

4. The method of clam 1, further comprising:
generating a checksum of the data block;
comparing the generated checksum to a checksum of the at least one object; and
updating the at least one object when the generated checksum does not match the checksum of the at least one object.

5. The method of claim 1, further comprising:
receiving a plurality of write instructions; and
storing the data block of the plurality of write instructions when the number of write instructions exceeds a predetermined threshold.

6. The method of claim 5, wherein the threshold is any of: static, dynamic, or adaptive.

7. The method of claim 1, further comprising:
receiving from an OC a request for a data block stored in the object storage;
retrieving the requested data block from the object storage; and
sending the data block retrieved from the object storage to the OC.

8. The method of claim 7, further comprising:
sending data stored in the at least one object of the object storage in response to the request from the OC; and
initializing a replicated component (RC), the RC comprising at least one storage corresponding to the at least one storage of the OC.

9. The method of claim 8, wherein the at least one object is mapped to corresponding data blocks stored in at least one storage of the RC.

10. The method of claim 9, wherein the at least one object is mapped in response to the RC receiving an input/output (I/O) request related a data block which is not currently restored.

11. The method of claim 1, further comprising:
detecting that the object storage and the block storage are not consistent; and
sending one or more data blocks to the object storage to recover consistency between the object storage and the block storage.

12. A non-transitory computer readable medium having stored thereon instructions for causing a processing circuitry to perform a process, the process comprising:
receiving write instructions from an original component (OC) in a first network, wherein the write instructions include a data block;
mapping the write instructions to at least one object in the object storage; and
storing the data block of the write instructions in the mapped at least one object in a second network.

13. A system for replicating block storage to an object storage, comprising:
a processing circuitry; and
a memory, the memory containing instructions that, when executed by the processing circuitry, configure the system to:
receive write instructions from an original component (OC) in a first network, wherein the write instructions include a data block;
map the write instructions to at least one object in the object storage; and
store the data block of the write instructions in the mapped at least one object in a second network.

14. The system of claim 13, wherein the system if further configured to:
store metadata associated with the data block in a storage map.

15. The system of claim 14, wherein the metadata includes at least one of: a timestamp and a logical address.

16. The system of clam 13, wherein the system if further configured to:
generate a checksum of the data block;
compare the generated checksum to a checksum of the at least one object; and
update the at least one object when the generated checksum does not match the checksum of the at least one object.

17. The system of claim 13, wherein the system if further configured to:
receive a plurality of write instructions; and
store the data block of the plurality of write instructions when the number of write instructions exceeds a predetermined threshold.

18. The system of claim 17, wherein the threshold is any of: static, dynamic, or adaptive.

19. The system of claim 13, wherein the system if further configured to:
receive from an OC a request for a data block stored in the object storage;
retrieve the requested data block from the object storage; and
send the data block retrieved from the object storage to the OC.

20. The system of claim 19, wherein the system if further configured to:
send data stored in the at least one object of the object storage in response to the request from the OC; and
initialize a replicated component (RC), the RC comprising at least one storage corresponding to the at least one storage of the OC.

21. The system of claim 20, wherein the at least one object is mapped to corresponding data blocks stored in at least one storage of the RC.

22. The system of claim 21, wherein the at least one object is mapped in response to the RC receiving an input/output (I/O) request related a data block which is not currently restored.

23. The system of claim 13, wherein the system if further configured to:
detect that the object storage and the block storage are not consistent; and
send one or more data blocks to the object storage to recover consistency between the object storage and the block storage.
